(19) United States
(12) Patent Application Publication
(10) Pub. No.: US 2007/0017321 A1
(43) Pub. Date: Jan. 25, 2007

(54) Adjustable and portable striking tool assembly

(76) Inventor: Lawrence E. Doney, Virginia Beach, VA (US)

Correspondence Address: Lawrence E. Doney, Suite 407, 161 Ottawa Ave., NW, Grand Rapids, MI, 49503, US

(21) Appl. No.: 11/184,089

(22) Filed: Jul. 19, 2005

(51) Int. Cl. B25D 1/00; B25B 23/16; B25G 1/04

(52) U.S. Cl. 81/20; 81/177.2

(57) ABSTRACT

Disclosed is an adjustable and portable striking tool assembly adapted to be increased or decreased in the tool length for the quick, easy, and effective repair/reaching of the items, like gutter nails, gutter rails, soffit panels, soffit slides, and the like, at elevated height or around roof level without the use of a ladder. The adjustable and portable striking tool assembly of the present invention comprises a telescopically adjustable inner handle received within an elongated cylindrical arbor forming an outer extendible handle, a fastening device capable of fastening said telescopically adjustable inner handle within said outer extendible handle and a retention means mechanically attached to a retention means on the outer extendible handle and holding the fastening device on another end.

### FIELD OF THE INVENTION

The present invention relates generally to striking tools, and particularly, to an adjustable striking tool assembly adapted to be increased or decreased in the tool length for the quick, easy, and effective repair/reaching of the items, like gutter nails, gutter rails, soffit panels, soffit slides, and the like, at elevated height or around roof level without the use of a ladder.

### BACKGROUND OF THE INVENTION

Anyone who has spent time working on gutters, soffits or similar items on a house or building would address the worst part of this sort of a job that the constant up and down on the ladder and the moving of the ladder. While much of this work requires the person to be at the elevated location, there is a great deal of it where the person moves the ladder, climbs two or three steps, taps something with a hammer and then goes back down and moves the ladder again. The constant stress of climbing up and down the ladder is tiring work that exposes the worker to possible fall injuries as well. While a conventional long-handled hammer like a sledgehammer would be excessively heavy to be used over ones head for any length of time, its weight would be too much for the lightweight items such as gutters and soffit and would likely destroy them.

U.S. Pat. No. 5,765,807 discloses a gutter hammer specifically designed for driving and removing gutter spikes and typically used to hold the gutters at the edge of the roof. Configurationally, the hammer comprises of a shaped groove or claw at the rear that has a straight channel that is adapted to hold the heads of gutter spikes as they are removed. The top portion of the head of the hammer has a knocker head that is raised above the rest of the head and is adapted for hammering upon so that the claw portions can be used to remove gutter spikes. The hammer disclosed in this patent does not address the issue of reusability of the same hammer for multipurpose heights. The length of the hammer handle is fixed in this disclosure and accordingly cannot serve the need for fixing and removing gutters using the same hammer at variable heights without changing the ladder height.

U.S. Pat. No. 5,007,224 discloses a tool and method for installing roof gutters on buildings. The tool discloses can be used to position the gutter temporarily against the building wall as the tool is held in one of the user's hands, without any attachment of the gutter or the tool to the building being necessary. This patent also does not disclose anything regarding the handle assembly of the hammer tool for purposes of extending/varying the length of the hammer handle.

U.S. Pat. No. 2,365,463 discloses a nail pulling tool provided as an attachment for a hammer or a similar tool designed to give a pulling action. The invention neither provide a variable hammer head assembly nor facilitate the length variable handle assembly for addressing the height issues during such works without the user dismounting from the support used therein for climbing.

The features of the aforecited prior art disclose a complex design and structural indices that hinder their performance. The prior art does not provide a device that has simple structural indices for reliable operation i.e. can be increased or decreased in the tool length for reaching items, like gutter nails, gutter rails, soffit panels, soffit slides, and the like, at or around roof level without the use of a ladder Therefore, the present scenario is punctuated by an emerging need for a multipurpose hand tool and more specifically a hammer that addresses the issue of variable tool head and could be used for works at varying heights by using a single hand tool without the user climbing up and down the ladder intermittently to meet the height requirement.

### SUMMARY OF THE INVENTION

In view of the foregoing disadvantages inherent in the above-mentioned prior art, the general purpose of the present invention is to provide an improved combination of convenience and utility, to include all the advantages of the prior arts, and to overcome the abovementioned disadvantages/drawbacks of the prior art.

It is therefore, a principal aspect of the present invention is to provide an adjustable and portable striking tool assembly that allows for the repair of items at elevated heights, which require the use of a striking tool without the use of a ladder in a manner, which is quick, easy and effective.

It is yet another aspect of the present invention to provide an adjustable and portable striking tool assembly comprises a telescopically adjustable inner handle received within an elongated cylindrical arbor forming an outer extendible handle; the adjustable inner handle is capable of receiving an adjustable tool head at an end opposite to the outer extendible handle.

In another aspect of the present invention, an adjustable and portable striking tool assembly comprises a telescopically adjustable inner handle having a first end and a second end configured with a locking mechanism, the adjustable inner handle further having a grip, may be knurled grip or the like, for holding the inner handle, an outer extendible handle having an open upper end and a lower end with a closed lower base, the upper end having locking means configured to mechanically couple with the locking mechanism of the telescopically adjustable inner handle, the lower base of the lower end is mechanically attached with a retention ring, the outer extendible handle further having a grip for holding the outer extendible handle capable of receiving the telescopically adjustable inner handle through the open upper end and a retention means, may be a rope, a chord, a lead or the like, mechanically attached to the retention ring. The locking mechanism may include a plurality of inner guide holes drilled therethrough on the second end of the telescopically adjustable inner handle and the locking means may be an outer guide hole drilled therethrough on the upper end of the outer extendible handle. The adjustable and portable striking tool assembly further may include a fastening device configured to couple the inner guide holes of the telescopically adjustable inner handle with the outer guide hole of the outer extendible handle.

In another aspect, the present invention provides an adjustable and portable striking tool assembly wherein the first end of the telescopically adjustable inner handle has means for coupling the adjustable tool head. The means may include external threads, a center threaded drill hole with a cap screw and the like.

In yet another aspect, the present invention provides for an adjustable tool head having a drilled central channel configured for receiving the first end of the telescopically adjustable inner handle. The drilled central channel further may include internal threads configured to mesh with the external threads of the first end of the telescopically adjustable inner handle.

In yet another aspect, the present invention provides for an adjustable tool head including a round tool head, a round pick tool head, a radius-forming pick tool head, a flashing tool head, a seam and corner tool head, a radius-forming seam and corner tool head, a coining radius tool head and the like.

In another aspect, the present invention provides a method for operating an adjustable and portable striking tool assembly for fixing a desired length. The method comprises configuring a telescopically adjustable inner handle having a first end and a second end configured with a locking mechanism which may include a plurality of inner guide holes drilled therethrough on said second end of said telescopically adjustable inner handle attaching an adjustable tool head having a drilled central channel to the telescopically adjustable inner handle at its first end, configuring an outer extendible handle having an open upper end with locking means which may include an outer guide hole drilled therethrough on said upper end of said outer extendible handle at its upper periphery and a lower end with a closed lower base, inserting the telescopically adjustable inner handle into the outer extendible handle through the open upper end of the outer extendible handle, and aligning the locking mechanism of the telescopically adjustable inner handle with the locking means of the outer extendible handle. The method may further include a fastening device configured to couple the inner guide holes of the telescopically adjustable inner handle with the outer guide hole of the outer extendible handle.

In yet another aspect, the present invention provides a method for operating an adjustable and portable striking tool assembly wherein the step of fixing a desired length include aligning one of the plurality of inner guide holes at the second end of the telescopically adjustable inner handle with the outer guide hole of the outer extendible handle by inserting the telescopically adjustable inner handle into the outer extendible handle through the open upper end of the outer extendible handle and fixing the length using the fastening device.

In yet another aspect, the present invention provides a method for operating an adjustable and portable striking tool assembly wherein the step of attaching an adjustable tool head may include configuring external threads on the first end of the telescopically adjustable inner handle and internal threads on drilled central channel of the adjustable tool head and meshing the internal threads with the external threads.

In another aspect, the present invention provides a method for operating an adjustable and portable striking tool assembly wherein the step of attaching an adjustable tool head may also include configuring a coaxial central threaded drill hole at the first end of the telescopically adjustable inner handle for receiving a cap screw, receiving the drilled central channel of the adjustable tool head within the first end of the telescopically adjustable inner handle, and screwing the adjustable tool head to the telescopically adjustable inner handle using the cap screw.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front elevation view of the adjustable and portable striking tool assembly 10, according to a preferred embodiment of the present invention;

FIG. 2a is a front view of the inner handle portion 20, according to a preferred embodiment of the present invention;

FIG. 2b is a front view of the inner handle portion 20, according to another embodiment of the present invention;

FIG. 3 is a front view of the outer extendible handle portion 30, according to a preferred embodiment of the present invention;

FIG. 4a is a front view of a round tool head 40, according to a preferred embodiment of the present invention;

FIG. 4b is a side view of the round tool head 40, according to a preferred embodiment of the present invention;

FIG. 5a is a front view of a round pick tool head 50, according to an alternate embodiment of the present invention;

FIG. 5b is a side view of the round pick tool head 50, according to an alternate embodiment of the present invention;

FIG. 6a is a front view of a radius-forming pick tool head 60, according to another embodiment of the present invention;

FIG. 6b is a side view of the radius-forming pick tool head 60, according to another embodiment of the present invention;

FIG. 6c is an opposing side view of the radius-forming pick tool head 60, according to another embodiment of the present invention;

FIG. 7a is a front view of a flashing tool head 70, according to a different embodiment of the present invention;

FIG. 7b is a side view of the flashing tool head 70, according to a different embodiment of the present invention;

FIG. 7c is an opposing side view of the flashing tool head 70, according to a different embodiment of the present invention;

FIG. 8a is a front view of a seam and corner tool head 80, according to a different embodiment of the present invention;

FIG. 8b is a side view of the seam and corner tool head 80, according to a different embodiment of the present invention;

FIG. 9a is a front view of a radius-forming seam and corner tool head 90, according to a different embodiment of the present invention;

FIG. 9b is a side view of the radius-forming seam and corner tool head 90, according to a different embodiment of the present invention;

FIG. 10a is a front view of a coining radius tool head 100, according to a another embodiment of the present invention; and

FIG. 10b is a side view of the coining radius tool head 100, according to another embodiment of the present invention.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however that the present invention is not limited to a particular striking tool device assembly shown and described. Rather, the principles of the present invention can be used with a variety of striking tool assembly configurations and structural arrangements. It is understood that various omissions, substitutions of equivalents are contemplated as circumstances may suggest or render expedient, but is intended to cover the application or implementation without departing from the spirit or scope of the claims of the present invention.

The present invention provides an adjustable and portable multipurpose hand tool assembly, and more specifically, a cost effective single hand striking tool assembly or hammer, for the quick, easy, and effective repair/reaching of the items, like gutter nails, gutter rails, soffit panels, soffit slides, and the like, at elevated/varying height or around roof level. The present invention further addresses the work requirement thereby serving the commercial viability of a single striking tool overcoming all the existing drawbacks.

The present invention provides for an adjustable and portable striking tool assembly having an adjustable tool head that addresses the need for variable tool heads for serving a variety of works and can be increased or decreased in the tool length for the quick, easy, and effective repair/reaching of the items, like gutter nails, gutter rails, soffit panels, soffit slides, and the like, at elevated/varying height or around roof level, without the user climbing up and down the ladder intermittently to meet the height requirement and changing the type of hammer. The present invention eliminates the need of additional tool to increase or decrease height thus overcoming all the existing drawbacks in the prior art.

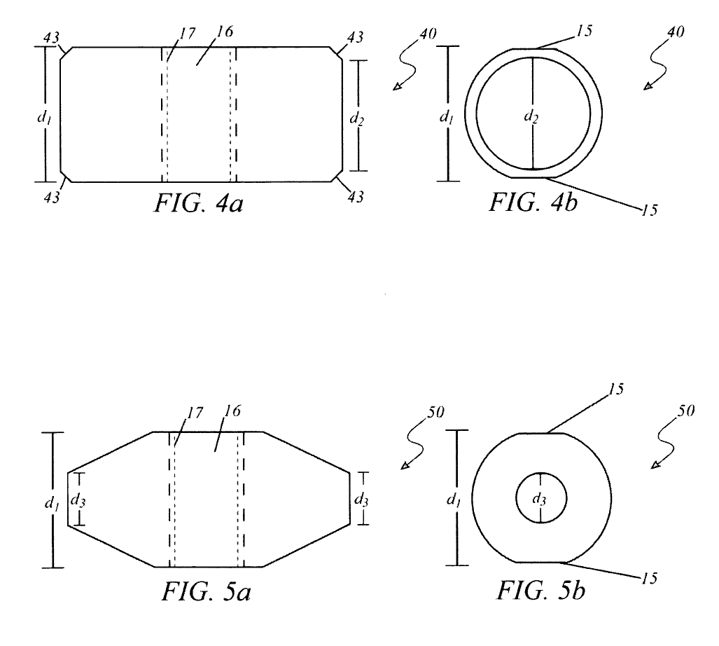

As illustrated in the provided drawings of the present invention, the adjustable striking tool assembly 10 (herein described as “assembly”) comprises a machined flat surface 15, drilled central channel 16, internal threads 17, telescopically adjustable inner handle 20, inner guide hole 21, threaded end 22, knurled grip of inner handle 23, center threaded drill hole 24, cap screw 25, outer extendible handle 30, outer guide hole 31, retention ring 32, retention means 33, fastening device 34, knurled grip of outer extendible handle 35, round tool head 40, chamfered end 43 having outer diameter d₁ and round tool head inner diameter d₂, round pick tool head 50 having inner diameter d₃, radius-forming pick tool head 60 having first radius r₁ and second radius r₂ (FIGS. 4a through 10b).

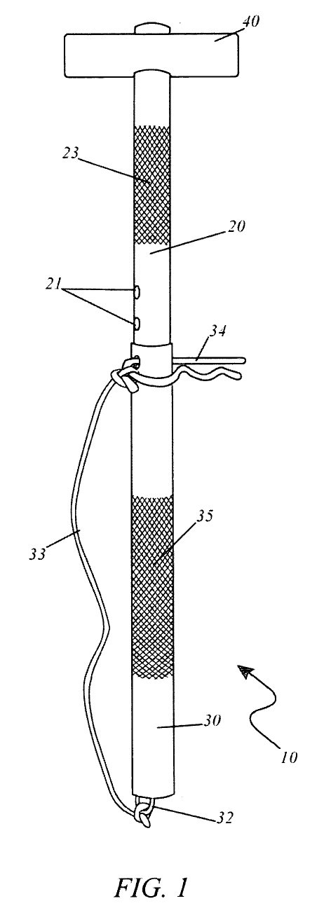

Referring now to FIG. 1 an adjustable and portable striking tool assembly 10 may be provided as a long-handled aluminum or similar lightweight material hammer that is used for gutter and soffit installation and repair and works of the like. The entire assembly 10 is presented here in FIG. 1 as a properly built apparatus with a typical round tool head portion 40 affixed thereupon.

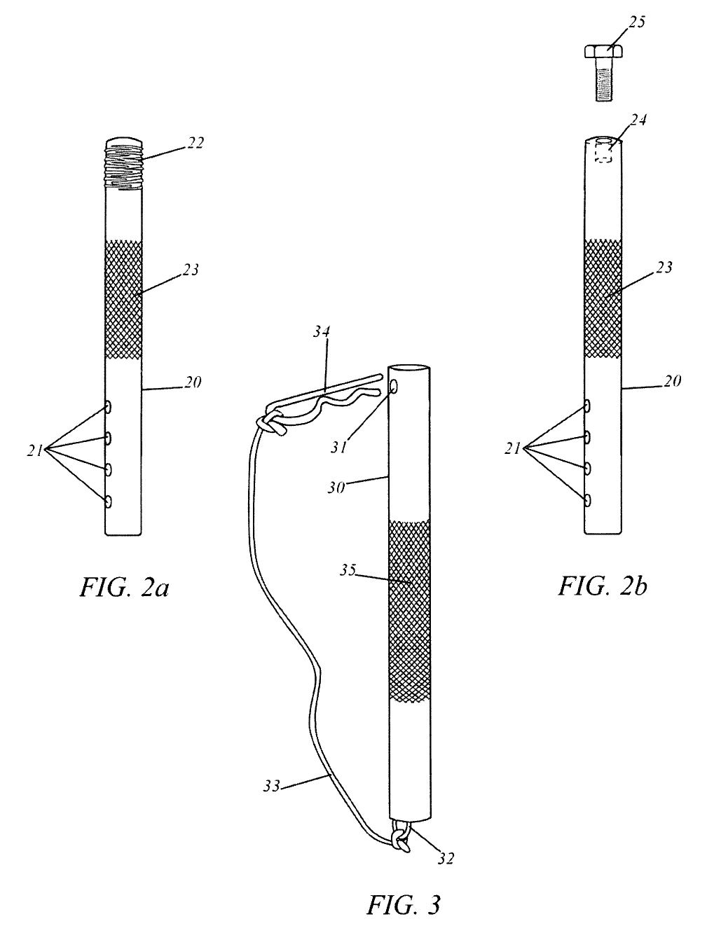

FIGS. 2a and 2b represent the inner handle portion 20 of the adjustable and portable striking tool assembly 10. The telescopically adjustable inner handle 20 comprises a cylindrical portion of round stock of a lightweight material such as aluminum has a first and second end. A series of guide holes 21 of a diameter slightly larger than the diameter of the fastening device 34 depicted in FIG. 1 are spaced equidistant from each other at the second end of the inner handle 20 at a predetermined distance and drilled therethrough. The guide holes 21 run up approximately ⅓ of the length of the inner handle 20. At the first end of the inner handle 20, it has means for coupling said adjustable tool head. The means for coupling may include external male threads 22 machined about its circumference to a length roughly matching that of the outer diameter of the interchangeable adjustable tool heads. A knurled grip 23 may be also machined on the outer circumference of the inner handle 20 within the space located between the machined coupling means and the guide holes 21. An alternate embodiment depicted in FIG. 2b illustrates a means for coupling as a drilled center hole with internal threads 24 located on the flat surface at the first end of the inner handle 20 opposite of the drilled guide holes 21, as well as a conventional cap screw 25 and the like. This alternate embodiment provides other means for affixing the interchangeable tool heads to the inner handle 20.

FIG. 3 refers to the outer extendible handle 30 of the adjustable and portable striking tool assembly 10 and comprises an elongated hollow cylindrical arbor roughly matching the inner handle 20 in length and slightly larger in diameter for the purpose of receiving said inner handle 20 with minimal clearance. The material may be the same as the inner handle 20 but in any case is preferably of a lightweight and durable material. The outer extendible handle 30 has an open upper end and a lower end with a closed lower base. The upper end has an outer guide hole 31 drilled therethrough of a similar diameter to the inner guide holes 21 of the inner handle 20. At the lower base of said lower end may be mechanically attached with a retaining ring 32 and retains via a knot or similar securing method a retention means 33 or similar device. At the opposite end of the retention means 33 and secured in a similar manner to the retaining ring 32 may be a fastening device 34. Said fastening device 34 (herein depicted as a hitch pin clip) has means to slide through the inner guide holes 21 and the outer guide holes 31 of the inner handle 20 and the outer extendible handle 30, and engage the outer circumference of said outer extendible handle 30 to disallow any movement of the inner handle 20 relative to the outer extendible handle 30. Located about its outer circumference may be a knurled grip 35 similar to that located on the circumference of the inner handle 20. The outer extendible handle 30 receives the telescopically adjustable inner handle 20 through the open upper end.

FIGS. 4a through 10b depict the different embodiments of the tool heads that can be attached to the inner handle 20 of the adjustable and portable striking tool assembly 10 of the present invention. The tool heads are manufactured out of similar round stock as the inner handle 20 and of a predetermined length. As shown in FIG. 4a, the outer diameter d₁ is determined by the width of the round stock used. A central channel 16 may be drilled therethrough at the determined top center portion of the tool head 40 and internal threads 17 are machined within the central channel 16 for threading the tool head onto the first end of the inner handle 20. Alternate embodiments of the adjustable and portable striking tool assembly of the present invention provide for only a central channel 16 to be drilled through the center of the tool head to receive the cap screw 25 to be used in affixing the desired tool head to the inner handle 20. A flat surface 15 may be machined from opposite ends of the outer circumference that matches the thickness of the inner handle 20 and is designed to rest thereupon. FIGS. 4a and 4b depict a round tool head 40 with chamfered ends 43 defining an inner diameter d₂ on both sides.

FIGS. 5a and 5b depict a round pick tool head 50 with an outer diameter d₁ that tapers down at a particular angle to an inner diameter d₃ on both sides, typically keeping the same length as the round tool head 40. Also shown is a flat surface 15 may be machined from opposite ends of the outer circumference that matches the thickness of the inner handle 20 and is designed to rest thereupon.

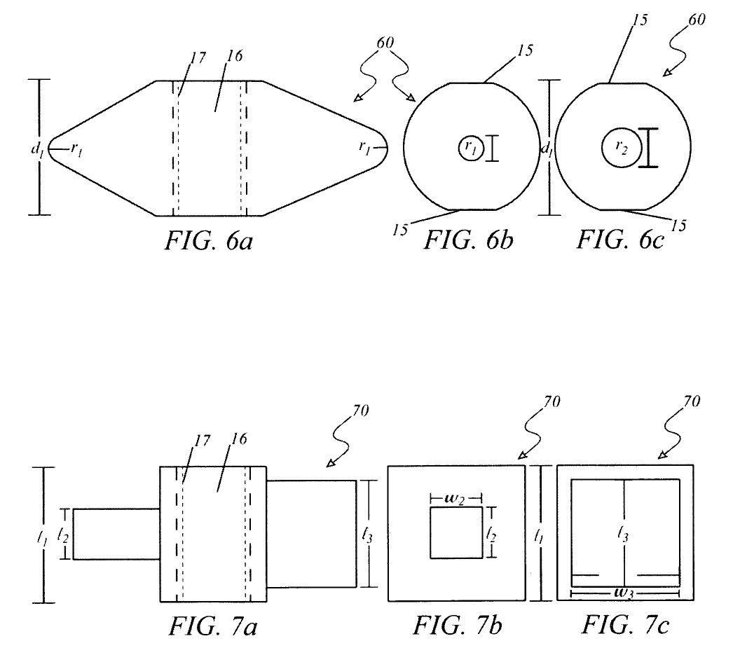

FIGS. 6a, 6b, and 6c all illustrate a radius-forming pick tool head 60 with an outer diameter d, that tapers down at a particular angle to two defined radii r₁ and r₂ at a particular angle, typically keeping the same length as the round tool head 40. For this particular embodiment, the second radius r₂ has larger dimensions than the first r₁, thus creating a more diverse tool capable of being used in diverse activities.

FIGS. 7a, 7b, and 7c all illustrate a flashing tool head 70 comprising a somewhat different configuration than the other tool heads. The flashing tool head is typically square in design and shape, typically keeping the same length as the round tool head 40. The two sides are rectangular in shape and extend outward from the center portion, where the length l₂, width ω₂ and length l₃ and width ω₃ of the other sides are different than the length l₁ and width ω₁ of the first side, thus creating a more diverse tool.

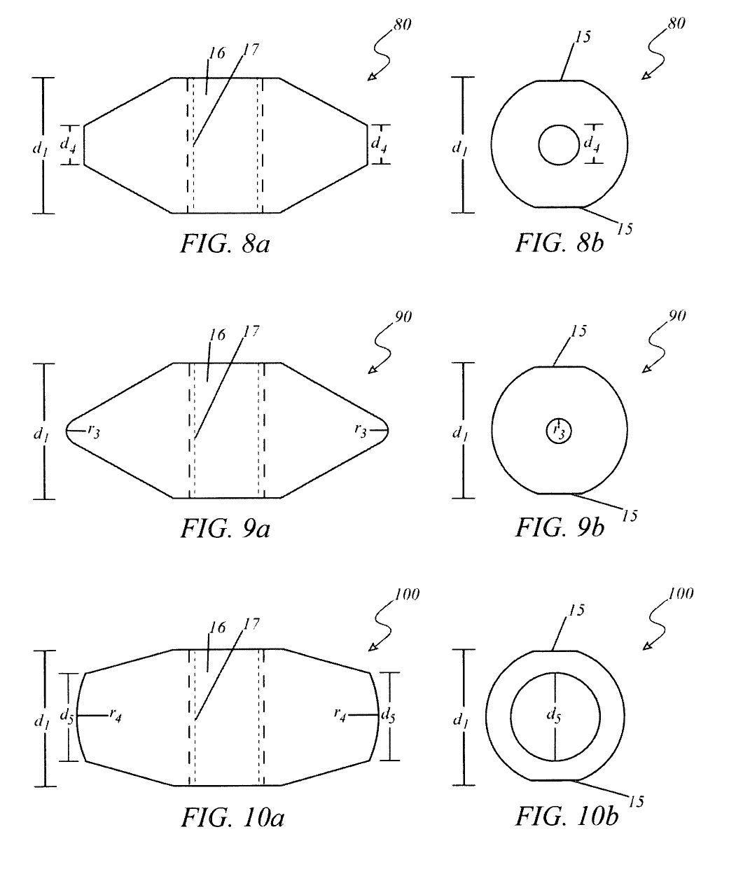

FIGS. 8a and 8b depict a seam and corner tool head 80 that is similar in shape to the round pick tool head 50 described in FIGS. 5a and 5b, but tapering down with a larger angle to define inner diameters d₄ on both sides smaller than that of the round pick tool 50.

FIGS. 9a and 9b illustrate a radius-forming seam and corner tool head 90 similar in shape to the radius-forming pick tool head depicted in FIGS. 6a through 6c, but tapering down at a larger angle to define two radii r₃ of equal dimensions smaller than that in the radius-forming pick tool head 60.

FIGS. 10a and 10b depict a coining radius tool head 100 that is similar in shape to the round pick tool head 50 described in FIGS. 5a and 5b, but with two convex inner diameters d₅ of a typical radius r₅ in order to provide different textures.

### OPERATION OF THE PREFERRED EMBODIMENT

The preferred embodiment of the present invention is designed to be used by an average person with minimal skills and no special training necessary.

The use of the present invention is particularly suited for work on residential and commercial buildings for those who wish to work on roof flashing work and also for masons or bricklayers in wooden form building work. With the added features of the interchangeable heads, the adjustable and portable striking tool assembly 10 of the present invention has added versatility limited only by the imagination and skills of the user.

Once the particular tool head (see FIGS. 4a through 10b) is chosen, based on the desired action or material to be worked, the user places the chosen head onto the inner handle 20 by either threading the inner handle portion 20 illustrated in FIG. 2a through the chosen hammer head, or, alternatively, by placing the tool head onto the inner handle 20 illustrated in FIG. 2b and securing with a coupling means as the likes of a cap screw 25 threaded through and engaging the female threads 24 within the top center of the inner handle 20.

Once the desired tool head is secured to the inner handle 20 by one of the methods described above, the user then determines if the extension handle 30 is necessary. If deemed necessary, the user has a variety of lengths to which the adjustable and portable striking tool assembly 10 of the present invention may be extended to. A series of inner guide holes 21 are drilled through the inner handle 20 at predetermined intervals which are designed to match up with the single hole 31 drilled through the outer extendible handle 30. Once the desired length is determined, the user aligns the corresponding inner guide hole 21 of the inner handle 20 with the outer guide hole 31 on the outer extendible handle 30 by sliding the inner handle 20 through the hollow outer extension handle 30 and places a fastening device 34 through both guide holes 21, 31. Fastening devices 34 anticipated to be best suited for the present invention adjustable and portable striking tool assembly 10 of the include hitch pins (see FIG. 1) and similar devices. The fastening device 34 is connected to a retention means 33 or similar device which may be attached to the base of the outer extendible handle 30 via a retention ring 32 for the purposes of retaining said fastening device 34 from accidental misplacement.

Once the desired length of the outer extendible handle 30 may be set via the fastening device 34 and the desired tool head may be affixed to the top of the inner handle 20; the user may then proceed to use the adjustable and portable striking tool assembly 10 according to the chosen work. Knurled grips 23, 35 are located on both the inner handle 20 and outer extendible handle 30 to provide added security and comfort for the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. An adjustable and portable striking tool assembly, comprising:
a telescopically adjustable inner handle received within an elongated cylindrical arbor forming an outer extendible handle, said adjustable inner handle configured to receive an adjustable tool head at an end opposite to said outer extendible handle.

2. An adjustable and portable striking tool assembly, comprising:
a telescopically adjustable inner handle having a first end and a second end configured with a locking mechanism, said adjustable inner handle further having a grip for holding said inner handle;
an adjustable tool head configured to be mechanically attached to said first end of said telescopically adjustable inner handle;
an outer extendible handle having an open upper end and a lower end with a closed lower base, said upper end having locking means configured to mechanically couple with said locking mechanism of said telescopically adjustable inner handle, said lower base of said lower end is mechanically attached with a retention ring, said outer extendible handle further having a grip for holding said outer extendible handle capable of receiving said telescopically adjustable inner handle through said open upper end; and
a retention means mechanically attached to said retention ring.

3. The adjustable and portable striking tool assembly of claim 2 wherein said locking mechanism may include a plurality of inner guide holes drilled therethrough on said second end of said telescopically adjustable inner handle and said locking means may be an outer guide hole drilled therethrough on said upper end of said outer extendible handle.

4. The adjustable and portable striking tool assembly of claim 3 further may include a fastening device configured to couple said inner guide holes of said telescopically adjustable inner handle with said outer guide hole of said outer extendible handle.

5. The adjustable and portable striking tool assembly of claim 2 wherein said grip may be a knurled grip or the like.

6. The adjustable and portable striking tool assembly of claim 2 wherein said retention means may be a rope, a chord, a lead or the like.

7. The adjustable and portable striking tool assembly of claim 2 wherein said first end of said telescopically adjustable inner handle has means for coupling said adjustable tool head.

8. The adjustable and portable striking tool assembly as recited in claim 7 wherein said means for coupling may include external threads, a center threaded drill hole with a cap screw, or the like.

9. The adjustable and portable striking tool assembly of claim 2 wherein said adjustable tool head has a drilled central channel configured for receiving said first end of said telescopically adjustable inner handle.

10. The adjustable and portable striking tool assembly as recited in claim 9 wherein said drilled central channel may include internal threads configured to mesh with said external threads of said first end of said telescopically adjustable inner handle.

11. A method for operating an adjustable and portable striking tool assembly for fixing a desired length comprising:
configuring a telescopically adjustable inner handle having a first end and a second end configured with a locking mechanism;
attaching an adjustable tool head having a drilled central channel to said telescopically adjustable inner handle at its first end;
configuring an outer extendible handle having an open upper end with locking means at its upper periphery and a lower end with a closed lower base;
inserting said telescopically adjustable inner handle into said outer extendible handle through said open upper end of said outer extendible handle; and
aligning said locking mechanism of said telescopically adjustable inner handle with said locking means of said outer extendible handle.

12. The method for operating an adjustable and portable striking tool assembly for fixing a desired length of claim 11 wherein said locking mechanism may include a plurality of inner guide holes drilled therethrough on said second end of said telescopically adjustable inner handle and said locking means may be an outer guide hole drilled therethrough on said upper end of said outer extendible handle.

13. The method for operating an adjustable and portable striking tool assembly for fixing a desired length of claim 11 further may include a fastening device configured to couple said inner guide holes of said telescopically adjustable inner handle with said outer guide hole of said outer extendible handle.

14. The method for operating an adjustable and portable striking tool assembly for fixing a desired length of claim 13 wherein the step of fixing a desired length may include:
aligning one inner guide hole at said second end of said telescopically adjustable inner handle with said outer guide hole of said outer extendible handle,
inserting said telescopically adjustable inner handle into said outer extendible handle through said open upper end of said outer extendible handle, and
fixing said length using said fastening device.

15. The method for operating an adjustable and portable striking tool assembly of for fixing a desired length of claim 11 wherein the step of attaching an adjustable tool head may include configuring external threads on said first end of said telescopically adjustable inner handle and internal threads on drilled central channel of said adjustable tool head and meshing said internal threads on said drilled central channel with said external threads on said first end of said telescopically adjustable inner handle.

16. The method for operating an adjustable and portable striking tool assembly for fixing a desired length of claim 11 wherein said step of attaching an adjustable tool head may also include:
configuring a coaxial central threaded drill hole at the first end of said telescopically adjustable inner handle for receiving a cap screw;
receiving said drilled central channel of said adjustable tool head within said first end of said telescopically adjustable inner handle; and
screwing said adjustable tool head to said telescopically adjustable inner handle using said cap screw thereby preventing the disengagement of said adjustable tool head from said telescopically adjustable inner handle.

17. The adjustable tool head of claim 11 wherein said tool head may include a round tool head, a round pick tool head, a radius-forming pick tool head, a flashing tool head, a seam and corner tool head, a radius-forming seam and corner tool head, a coining radius tool head and the like.
